(19) United States
(12) Patent Application Publication
(10) Pub. No.: US 2008/0148509 A1
(43) Pub. Date: Jun. 26, 2008

(54) CONNECTABLE-DISCONNECTABLE SHROUD-CONNECTOR-ADAPTER

(76) Inventors: Joseph C. Bacarella, LaSalle, MI (US); Van T. Walworth, Lebanon, TN (US); Craig Whitaker, Fairfield, OH (US); William McGinn, Paragould, AR (US); David B. Hook, Franklin, TN (US)

Correspondence Address: HARNESS, DICKEY & PIERCE, P.L.C., P.O. BOX 828, BLOOMFIELD HILLS, MI, 48303, US

(21) Appl. No.: 11/955,690

(22) Filed: Dec. 13, 2007

Related U.S. Application Data
(60) Provisional application No. 60/875,184, filed on Dec. 15, 2006.

(51) Int. Cl. B60S 1/04

(52) U.S. Cl. 15/250.32

(57) ABSTRACT

A shroud-adapter for attaching a windshield wiper blade/beam assembly to a windshield wiper arm, comprising either a unitary or two-piece shroud-adapter which is detachably attachable to a connector element by snapping means, the connector element being attached to a wiper blade/beam assembly. The connector is of formed steel with crimp tabs bendable to impinge upon the wiper beam, but can be made from plastics or other suitably-engineered polymers or castings known in the field. The shroud-adapter portion can be molded from plastic or suitably-engineered materials or cast from any one of numerous materials. If a separate adapter portion is used in cooperation with the shroud, it can be molded from a plastic or suitably-engineered material, as well, but also can be cast, machined or formed by other appropriate methods. The shroud-adapter is designed to be compatible with many of the popular side pin, J-hook, and European style wiper arms.

### CROSS-REFERENCE TO RELATED APPLICATIONS

This application claims the benefit of U.S. Provisional Application No. 60/875,184, filed on Dec. 15, 2006. The disclosure of the above applications is incorporated herein by reference.

### FIELD

The present disclosure relates to windshield wiper blade assemblies. More specifically, the present disclosure relates to connector means for attaching windshield wiper blades to a wiper arm.

### BACKGROUND

The statements in this section merely provide background information related to the present disclosure and may not constitute prior art.

Beam style wiper blades use connectors to attach the beam of the windshield wiper blade to the wiper arm using various systems. One system is a slip-on connector snapped into a slot on the beam. A variety of adapters are used in conjunction with the connector to attach to a wiper arm. Most of these adapters do not fit more than one or two styles of wiper arms. There are several dozen styles of wiper arms in the market place; however, there are only about five styles that currently account for about 95% of all domestic U.S. wiper arm styles. Therefore, some adapters are designed to combine these five primary wiper arm styles. Some of these adapters are two-piece constructions, while others are of one-piece construction. Additionally, a new wiper arm connection style recently introduced in the European markets is beginning to have a presence in the U.S. market.

Some current product variations of beam style wipers in the market place provide a single adapter version for a specific application. Other product variations of beam style wipers provide a variety of adapters, which the consumer selects from to assemble to match their specific application. In both of these variations on the theme of current methods, a separate portion is assembled over the connector to hide or shroud the connector from view. In current methods, the shroud is not provided as an interchangeable component. Rather, in some prior art, the shroud provides a fixed cover over the connector for a specific attachment means. In other prior art, the shroud provides a fixed cover over the connector, which further serves as a mating component to accept a specific connector for a specific attachment means.

Disadvantages of the prior art forms of adapters are apparent in that many adapters require multiple pieces in the product package for the consumer, which are difficult to discern how to use and/or attach. Loose pieces are easily lost and/or the wrong piece is used to install the wiper—all leading to poor wipe quality and/or customer dissatisfaction with the product. Disadvantages of universal adapters that are multi-piece systems introduce some of the problems just discussed. One disadvantage of one-piece universal adapters is that they have no ability to accommodate new systems similar to the European arm styles growing rapidly in popularity. Another disadvantage is that some adapters require some kind of tool to facilitate assembly.

In addition, the fixed nature of the shroud portion requires that either the shroud must be designed for a specific attachment application or that the shroud portion must be made to accept a specific adapter application. The fixed nature of the shrouds in the current methods mandates that the shroud component must be assembled by the manufacturer, further mandating that the cost of the shroud assembly is incurred by the manufacturer.

### SUMMARY

In view of the above shortcomings in the prior art, it is an object of the present invention to provide a firm and secure method of connection between the connector and the wiper arm.

A further object of the present invention is to provide a shroud around the connector to cooperate with the connector to hide and/or assist the crimping and stabilization functions of the wiper assembly.

Another object of the present invention is to provide a shroud to cooperate with the connector to make a smooth transition between the wind deflector of the wiper blade and the connector to provide aerodynamic performance at the shroud and connector location.

Another object of the present invention is to provide a stylized cosmetic appearance around the connector.

A further objective of the present invention is to provide a shroud-adapter that provides attachment to the most popular wiper arm styles and the European arm style, either by universal design and/or individual specific design application.

Another objective is to provide a product that allows the customer to select which shroud-adapter fits their specific application and make an easy assembly at point of purchase and installation.

Lastly, it is an objective to provide the shroud-adapter components unassembled in the package so that the manufacturer does not incur the incremental cost of the assembly of a fixed shroud-adapter component.

These objectives are accomplished in a preferred embodiment providing a connector made of formed steel with crimp tabs bendable to impinge upon the wiper beam. The connector can be made from plastics or other suitably-engineered polymers or castings known in the field. The shroud-adapter portion can be molded from plastic or suitably-engineered materials or cast from any one of numerous materials. If a separate adapter portion is used in cooperation with the shroud, it can be molded from a plastic or suitably-engineered material as well, but can also be cast, machined or formed by other appropriate methods. The shroud-adapter is easily assembled to the connector by way of snapping, and may be either assembled on the connector by the manufacturer or placed loose in the selling package to be assembled by the customer after purchase.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial perspective view of a preferred embodiment shroud-adapter assembly attached to a wiper beam;

FIG. 2 is a partial perspective view of the wiper beam and blade illustrating the location of attachment of the shroud-adapter thereupon;

FIG. 3a is a perspective view of a first embodiment of a connector for attachment to the wiper blade assembly;

FIG. 3b is a perspective view of a second embodiment of a connector for attachment to the wiper blade assembly;

FIG. 4 is a partial perspective view of the connector of FIG. 3a attached to a wiper beam;

FIG. 5a is a perspective view of a first embodiment of shroud-adapter for attaching large J-style wiper arms;

FIG. 5b is a perspective view of a second embodiment of shroud-adapter for attaching small J-style wiper arms;

FIG. 5c is a perspective view of a third embodiment of shroud-adapter for attaching side-pin style wiper arms; and

FIG. 5d is a perspective view of a fourth embodiment of shroud-adapter for attaching twist-lock style wiper arms.

### DETAILED DESCRIPTION

The following description is merely exemplary in nature and is not intended to limit the present disclosure, application, or uses. It should be understood that throughout the drawings, corresponding reference numerals indicate like or corresponding parts and features.

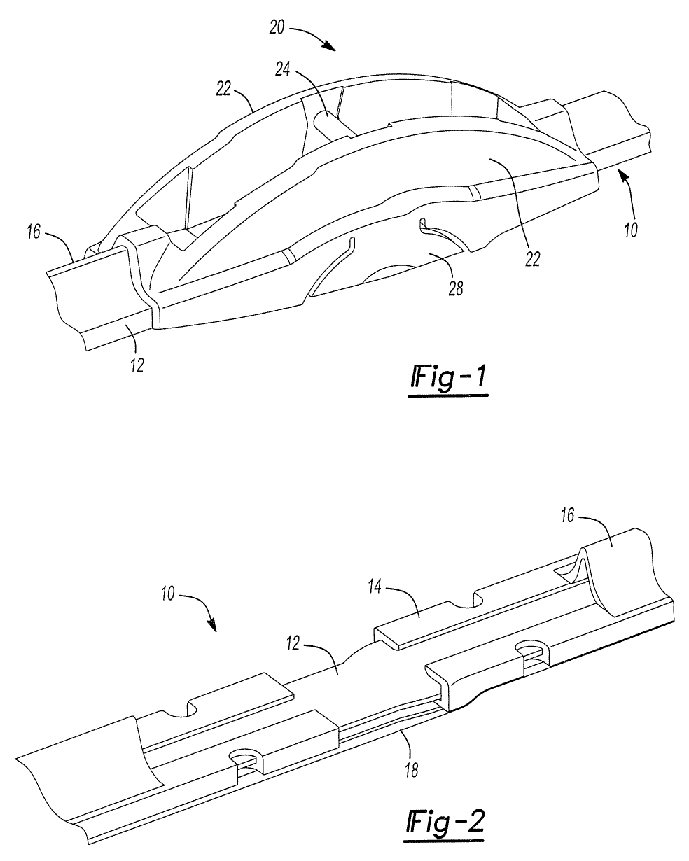

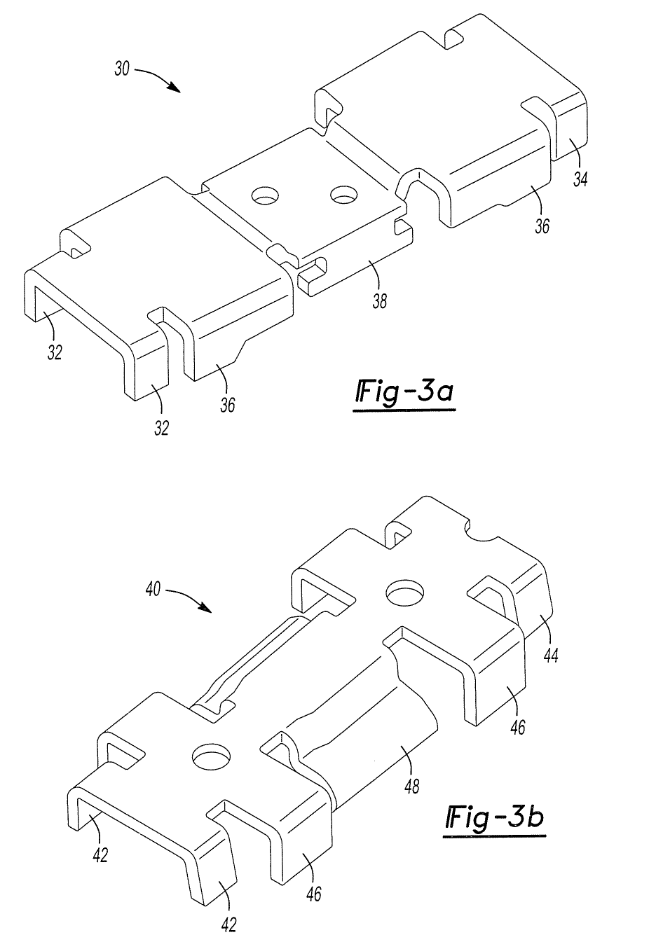

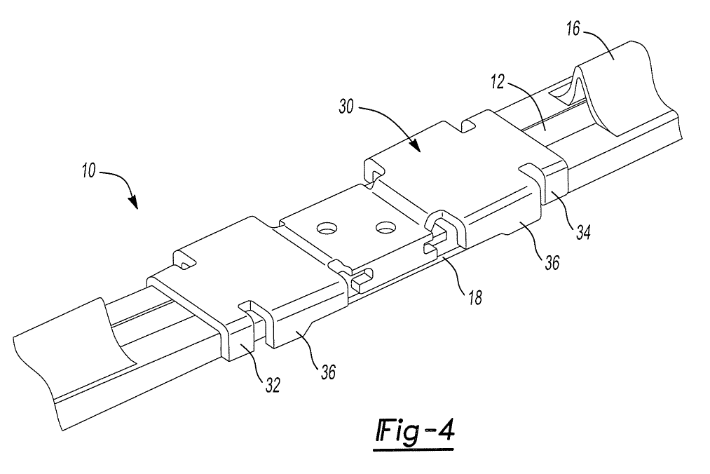

Referring now to the figures, particularly FIG. 1, a view of a first embodiment shroud-adapter assembly attached to a wiper beam is shown. The wiper blade/beam assembly 10 comprises a resilient portion having molded wind deflector 16 and wiping portion surrounding the semi-rigid beam member 12 shown in FIG. 2. The shroud-adapter assembly 20 is attached at a predetermined location along the blade/beam assembly 10. This general embodiment for attaching the wiper blade assembly to a wiper arm is molded to comprise a pair of generally-parallel walls 22 extending vertically from the wiper blade, interconnected by a cross-pin 24, which secures one of several separately-attachable and disconnectable adapters for the hook-style wiper arm. A pair of deflectable snap-locking legs 28 extends downward from walls 22 along the lateral sides 12 of blade/beam assembly 10 and subsequently snap-locks onto the connector (shown in FIGS. 3a and 3b) attached to the wiper blade/beam assembly 10.

FIG. 2 illustrates the attachment location of the shroud-adapter assembly. The rigid, longitudinally-running beam 12 supports the resilient member 14 of the blade assembly 10, which has a windshield-wiping edge 18 extending downward from the blade and a wind deflector portion 16 extending upwards, providing additional downward force upon the wiper blade assembly from wind force. The cutaway portion of the resilient member 14 illustrates the location for attaching the connector 30 of FIGS. 3a and 3b which subsequently holds the shroud-adapter assembly of the present invention.

The connector 30 in a preferred embodiment is formed from steel with crimp tabs 32, 34 bendable to impinge upon the wiper beam, but alternatively can be made from plastics or other suitable engineered polymers or castings known in the field. Pairs of downward, position-orienting legs 36 retain the wiper blade in position during crimping and further prevent lateral movement between the connector 30 and the wiper blade assembly. A mid portion is defined with attachment legs 38, which serve as the snapping lock for the subsequently-attached shroud-adapter assembly 20.

FIG. 3b illustrates an alternative-embodiment connector generally shown as 40. Crimp tabs 42, 44 are bendable to impinge upon the wiper beam, but alternatively can be made from plastics or other suitable engineered polymers or castings known in the field. Pairs of downward, position-orienting legs 46 retain the wiper blade in position during crimping and further prevent lateral movement between the connector 40 and the wiper blade assembly. A mid portion is defined with attachment legs 48, which serve as the snapping-lock means for the subsequently-attached shroud-adapter assembly 20.

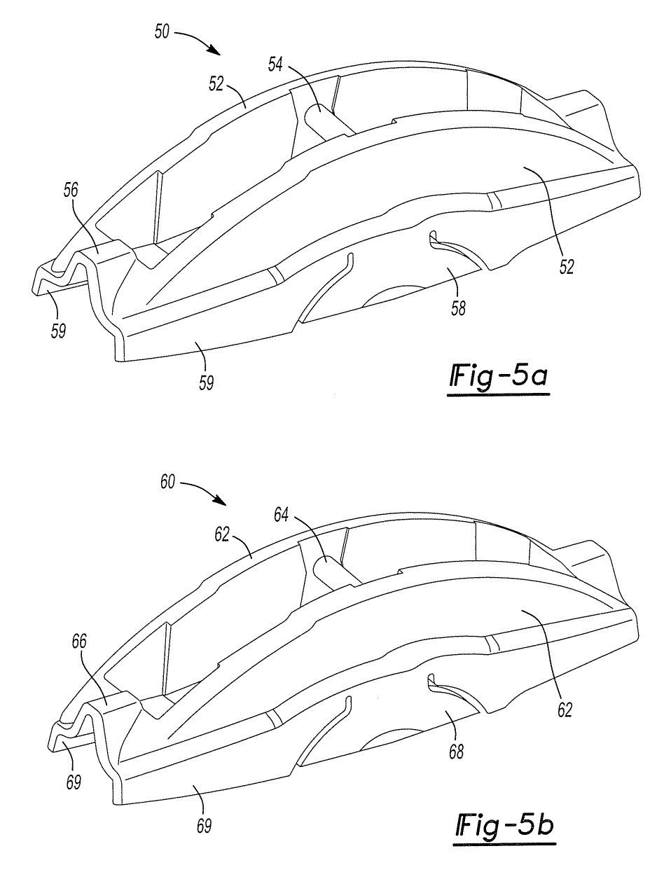

In either of the two above embodiments, the crimp tabs 32, 34, 42, 44 may be preformed and set into final place during the assembly-crimping process. The crimp tabs can be formed with multiple angles, sides, and bends as may be necessary for the application. The crimp tabs can also be preformed prior to assembly, or some contours of the specific connector crimp tabs may be formed during the actual assembly process. Crimp tabs molded from polymers can also be utilized to lock the connector in place and, as shown in FIG. 4, the connector 30 is attached to wiper beam/blade assembly 10 at the predetermined location.

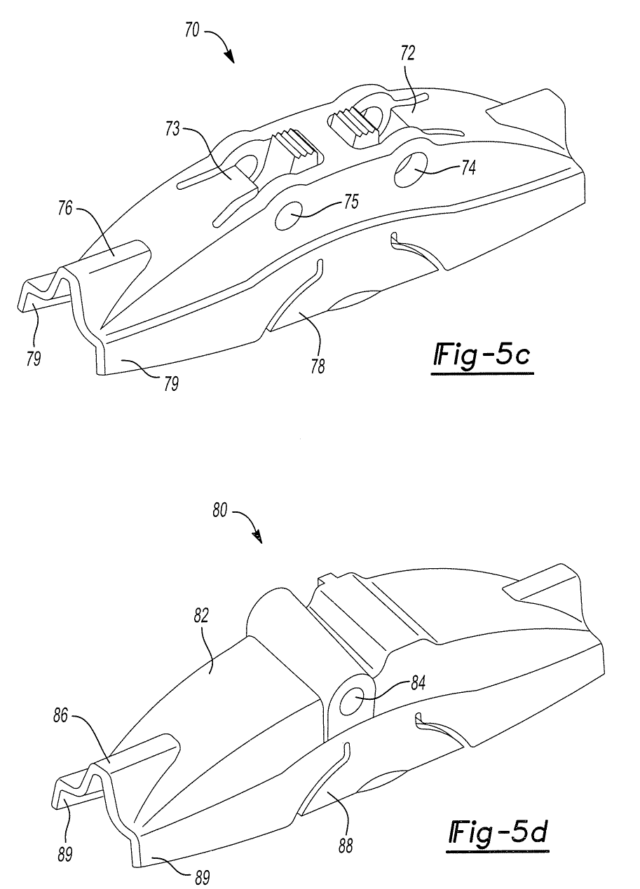

The shroud-adapters shown in FIGS. 5a-5d easily assemble onto the connector by snapping onto the respective attachment legs 38, 48 as mentioned above. Many unique attachment methods for the shroud exist and are intended to be within the scope of the present invention and can be assembled on the connector by the manufacturer or placed loose in the selling package to be assembled by the customer after purchase.

The shroud-adapters easily snap onto the connector without the use of tools and can be removed without damage to the shroud-adapter or connector. The connection method provides a positive lock between the shroud-adapter and the connector to prevent accidental separation or removal.

One specific shroud-adapter 50, shown in FIG. 5a, comprises a pair of parallel, vertical walls 52 interconnected by a pin element 54 to receive one of several separately-attachable and disconnectable adapters for numerous styles of large, J-hook wiper arms. The pin 54 can be integrally molded as one piece with the shroud-adapter or provided as a separate pin assembled into the shroud-adapter. The shroud-adapter with its integral pin will also accept specialized adapters or universal adapters and comprises a pair of ridges 56, one on each end for receiving the wind deflector portion of the wiper blade, maintaining the continuity of the aerodynamics of the blade. A pair of deflectable snap-locking legs 58 extends downward from walls 52 along the lateral sides of the blade/beam assembly and subsequently snap-lock onto the connector (shown in FIGS. 3a and 3b) attached to the wiper blade/beam assembly. Walls 59, positioned on either side of the shroud-adapter, retain the wiper blade in position and further prevent lateral movement between the shroud-adapter and the wiper blade assembly.

A second shroud-adapter 60, shown in FIG. 5b, comprises a pair of parallel, vertical walls 62 interconnected by a pin element 64 to receive one of several separately-attachable and disconnectable adapters for numerous styles of large, J-hook wiper arms. The pin 64 can be integrally molded as one piece with the shroud-adapter or provided as a separate pin assembled into the shroud-adapter. The shroud-adapter with its integral pin 64 will also accept specialized adapters or universal adapters and comprises a pair of ridges 66, one on each end for receiving the wind deflector portion of the wiper blade, maintaining the continuity of the aerodynamics of the blade. A pair of deflectable snap-locking legs 68 extends downward from walls 62 along the lateral sides of the blade/beam assembly and subsequently snap-lock onto the connector (shown in FIGS. 3a and 3b) attached to the wiper blade/beam assembly. Walls 69, positioned on either side of the shroud-adapter, retain the wiper blade in position, and further prevent lateral movement between the shroud-adapter and the wiper blade assembly.

Referring now to FIG. 5c, a third embodiment for the shroud-adapter 70 is shown, which contains features that receive the side pin style wiper arms. The side pins will be restrained by flexible retainer portions 72, 73 of the shroud-adapter that snap into the retention groove of the side pin. The leading end of the side pin of the wiper arm contacts the flexible retainer portion of the shroud-adapter as it is inserted into the shroud-adapter hole 74, 75. The flexible shroud-adapter portions 72, 73 retreat, letting the side pin slide past them until a groove on the side pin is properly positioned in the hole of the shroud-adapter, at which point the flexible portion 72, 74 snaps into the side pin groove to retain it. Removal of the side pin is accomplished by pressing on the flexible portion 72, 74 in a specific location to retract it out of the side pin groove, which allows the side pin to be extracted from the shroud-adapter 70.

The shroud-adapter comprises a pair of ridges 76, one on each end for receiving the wind deflector portion of the wiper blade, maintaining the continuity of the aerodynamics of the blade. A pair of deflectable snap-locking legs 78 extends downward along the lateral sides of the blade/beam assembly and subsequently snap-locks onto the connector (shown in FIGS. 3a and 3b) attached to the wiper blade/beam assembly. Walls 79, positioned on either side of the shroud-adapter, retain the wiper blade in position and further prevent lateral movement between the shroud-adapter and the wiper blade assembly.

In a further embodiment, shown in FIG. 5d, the shroud-adapter 80 contains a feature 82 suitable to cooperate with the connector to receive the European style wiper arm. The shroud-adapter 80 has a specific hole 84 located to receive the pin portion of the European wiper arm and construction suitable to receive the angled side plate of the European style wiper arm. The shroud-adapter comprises a pair of ridges 86, one on each end for receiving the wind deflector portion of the wiper blade, maintaining the continuity of the aerodynamics of the blade. A pair of deflectable snap-locking legs 88 extends downward along the lateral sides of the blade/beam assembly and subsequently snap-locks onto the connector (shown in FIGS. 3a and 3b) attached to the wiper blade/beam assembly. Walls 89, positioned on either side of the shroud-adapter, retain the wiper blade in position, and further prevent lateral movement between the shroud-adapter and the wiper blade assembly.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An adapter for attaching a windshield wiper blade assembly to a windshield wiper arm, said adapter comprising:
a connector element, said connector element having a central portion, two transitionary portions and two distal portions, said connector element being attached to a central portion of a windshield wiper blade assembly; and
a unitary shroud adapter, said shroud adapter being detachably attachable to a pair of lateral attachment legs of said central portion of the connector element by snapping means.

2. The adapter of claim 1, wherein said connector element is formed of steel and comprises a pair of lateral crimp tabs on each of said distal portions of said connector elements, said crimp tabs bendable to impinge upon a resilient portion of said wiper blade assembly.

3. The adapter of claim 2, wherein both of said transitionary portions of said connector element comprises a pair of downward-oriented lateral legs, said lateral legs are positioned on either side of said windshield wiper blade assembly when connector element is attached.

4. The adapter of claim 1, wherein said shroud adapter comprises two distal ends, a central portion and a pair of parallel, vertical walls interconnected by a pin element, said pin element adapted to receive a separately-attachable and disconnectable adapter for attaching said wiper blade assembly to windshield wiper arm having a J-shaped hook, said pin element being integrally molded as one piece with the shroud adapter, said shroud adapter further comprises a pair of ridges, one on each of said distal ends, which receive a wind deflector portion of the wiper blade assembly when attached thereto, said shroud adapter further comprising a pair of deflectable snap locking legs extending downward from said vertical walls proximal said central portion, said snap locking legs being detachably attachable to said lateral attachment legs of said central portion of the connector element by snapping means

5. The shroud adapter of claim 4, wherein said pin element is a separate component attached to said shroud adapter.

6. The adapter of claim 4, wherein said shroud adapter comprises two distal ends, a central portion and retainer portion for attaching a windshield wiper arm having a lateral pin attachment means, said retainer portion comprising at least one lateral aperture, and a deflectable tab engaging with said lateral pin of said windshield wiper arm, detachably attaching the windshield wiper arm to said shroud adapter.

7. The adapter of claim 1, wherein said connector element is formed of a polymer and comprises a pair of lateral crimp tabs on each of said distal portions of said connector elements, said crimp tabs bendable to impinge upon a resilient portion of said wiper blade assembly.

8. The adapter of claim 4, wherein both of said transitionary portions of said connector element comprises a pair of downward-oriented lateral legs, said lateral legs are positioned on either side of said windshield wiper blade assembly when connector element is attached.

9. An adapter for attaching a windshield wiper blade assembly to a windshield wiper arm, said adapter comprising:
a connector element, said connector element having a central portion, two transitionary portions and two distal portions, said connector element being attached to a central portion of a windshield wiper blade assembly; and
a two-piece shroud adapter, said shroud adapter being detachably attachable to a pair of lateral attachment legs of said central portion of the connector element by snapping means.

10. The adapter of claim 9, wherein said connector element is formed of steel and comprises a pair of lateral crimp tabs on each of said distal portions of said connector elements, said crimp tabs bendable to impinge upon a resilient portion of said wiper blade assembly.

11. The adapter of claim 10, wherein both of said transitionary portions of said connector element comprises a pair of downward-oriented lateral legs, said lateral legs are positioned on either side of said windshield wiper blade assembly when connector element is attached.

12. The adapter of claim 9, wherein said shroud adapter comprises two distal ends, a central portion and a pair of parallel, vertical walls interconnected by a pin element, said pin element adapted to receive a separately-attachable and disconnectable adapter for attaching said wiper blade assembly to windshield wiper arm having a J-shaped hook, said pin element being integrally molded as one piece with the shroud adapter, said shroud adapter further comprises a pair of ridges, one on each of said distal ends, which receive a wind deflector portion of the wiper blade assembly when attached thereto, said shroud adapter further comprising a pair of deflectable snap locking legs extending downward from said vertical walls proximal said central portion, said snap locking legs being detachably attachable to said lateral attachment legs of said central portion of the connector element by snapping means

13. The shroud adapter of claim 12, wherein said pin element is a separate component attached to said shroud adapter.

14. The adapter of claim 12, wherein said shroud adapter comprises two distal ends, a central portion and retainer portion for attaching a windshield wiper arm having a lateral pin attachment means, said retainer portion comprising at least one lateral aperture, and a deflectable tab engaging with said lateral pin of said windshield wiper arm, detachably attaching the windshield wiper arm to said shroud adapter.

15. The adapter of claim 9, wherein said connector element is formed of a polymer and comprises a pair of lateral crimp tabs on each of said distal portions of said connector elements, said crimp tabs bendable to impinge upon a resilient portion of said wiper blade assembly.

16. The adapter of claim 12, wherein both of said transitionary portions of said connector element comprises a pair of downward-oriented lateral legs, said lateral legs are positioned on either side of said windshield wiper blade assembly when connector element is attached.
